(19) United States
(12) Patent Application Publication
(10) Pub. No.: US 2012/0020784 A1
(43) Pub. Date: Jan. 26, 2012

(54) ANTI-ROTATION FEATURE FOR AIR TURBINE STARTER

(76) Inventors: William C. Trommer, Byron, IL (US); Jeffrey M. Makulec, Rockford, IL (US)

(21) Appl. No.: 12/842,094

(22) Filed: Jul. 23, 2010

(51) Int. Cl. F04D 29/04; B23P 19/00

(52) U.S. Cl. 415/229; 29/700

(57) ABSTRACT

A turbine balance assembly has a turbine rotor and shaft. Bearings are positioned radially outwardly of the shaft. A bearing sleeve is positioned radially outwardly of the bearings, and supports the bearings. The bearing sleeve extends along an axial length defined by a rotational axis of the shaft, and has a turbine rotor end adjacent to the turbine rotor, and a remote end. A radially outwardly extending flange on the bearing sleeve extends radially outwardly of a support portion of the bearing sleeve at the turbine rotor end. The flange has a nominal outer diameter, and includes a slot for receiving an anti-rotation tab from a gear cage over a first circumferential extent. A bearing sleeve incorporates the anti-rotation feature, and a gear cage incorporates its portion of the anti-rotation feature. An air turbine starter, and a method of installing components of a turbine balance assembly are also disclosed.

### BACKGROUND

This application relates to an anti-rotation feature between a gear cage, and a bearing sleeve in an air turbine starter turbine assembly.

Air turbine starter turbine assemblies are utilized to provide a starter function in gas turbine engines. In a typical air turbine starter turbine assembly, an auxiliary power unit (APU) is utilized to provide power prior to start-up of the main gas turbine engine. The compressed air from the APU is directed into an inlet of the air turbine starter turbine assembly, and drives a turbine rotor to rotate. The turbine rotor rotates, and serves as a starter motor for the main gas turbine engine.

A bearing sleeve surrounds a turbine shaft, and a plurality of bearings support the shaft within the bearing sleeve. During drive of the air turbine starter turbine assembly, there are rotational forces applied to the bearing sleeve, which could cause it to rotate. The bearing sleeve extends from a turbine rotor end adjacent to the turbine rotor, and to a gear end adjacent to a planetary gear.

In the prior art, a pin or other lock locks the bearing sleeve to a gear cage at the gear end of the bearing sleeve. With vibration and use, debris can be generated, and the debris can gain access into the interior of the air turbine starter turbine assembly.

### SUMMARY

A turbine balance assembly has a turbine rotor connected to drive a turbine shaft. Bearings are positioned radially outwardly of the turbine shaft. A bearing sleeve is positioned radially outwardly of the bearings, and supports the bearings. The bearing sleeve extends along an axial length defined by a rotational axis of the shaft, and has a turbine rotor end adjacent to the turbine rotor, and a remote end. A radially outwardly extending flange on the bearing sleeve extends radially outwardly of a support portion of the bearing sleeve at the turbine rotor end. The flange has a nominal outer diameter, and includes a slot for receiving an anti-rotation tab from a gear cage over a first circumferential extent.

A bearing sleeve incorporating the anti-rotation feature, a gear cage incorporating its portion of the anti-rotation feature, an air turbine starter, and a method of installing components of a turbine balance assembly are also disclosed and claimed.

These and other features of the present invention can be best understood from the following specification and drawings, the following of which is a brief description.

### BRIEF DESCRIPTION OF THE DRAWINGS

FIG. 1 shows an air turbine starter turbine assembly.

FIG. 2A shows a bearing sleeve.

FIG. 2B shows a gear cage and bearing sleeve combination.

FIG. 3 shows a cross-section through the assembly of FIG. 1.

FIG. 4A shows a first fabrication step.

FIG. 4B shows a subsequent fabrication step.

FIG. 5 shows a detail of a liner.

FIG. 6 shows a detail of the bearing sleeve.

FIG. 7 shows a side view of the bearing sleeve.

FIG. 8 shows a detail of the gear cage.

FIG. 8B shows a second detail of a gear cage.

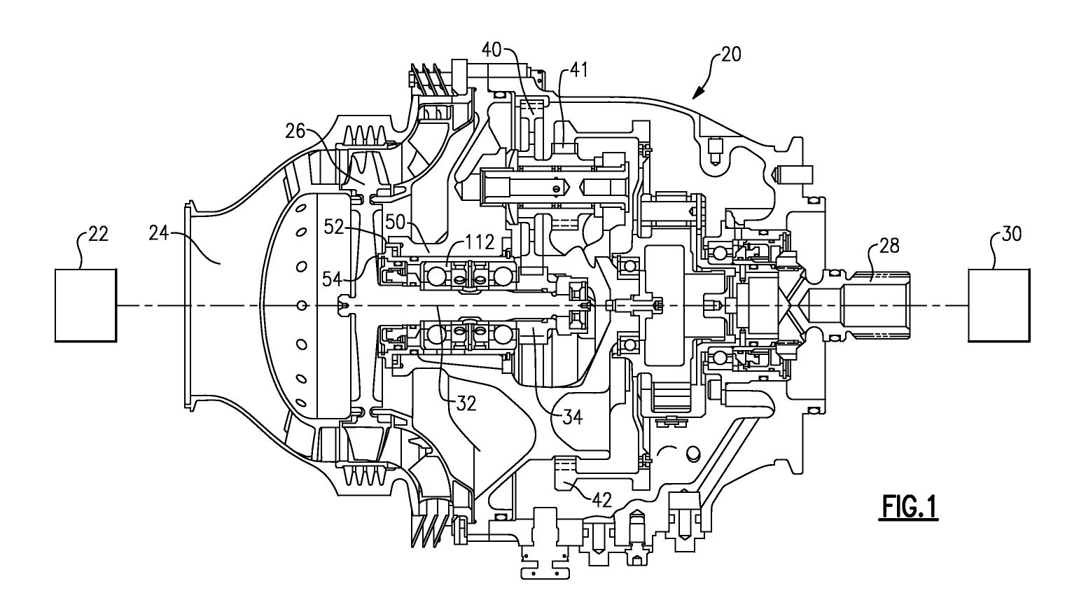

### DETAILED DESCRIPTION

An air turbine starter turbine assembly 20 may be associated with an aircraft, or other systems including a gas turbine engine. A source of hot air 22, which may be an auxiliary power unit, as typically utilized while on the ground, delivers hot, high pressure air into an inlet 24. The high pressure air flows across a turbine rotor 26, causing the turbine rotor 26 to rotate. As the turbine rotor 26 rotates, it rotates an output shaft 28 through a planetary gear system. The output shaft 28 may be utilized as a starter, to start operation of a main gas turbine engine 30.

A planetary gear system includes a sun gear 34 that is driven by a turbine shaft 32 that rotates with the turbine rotor 26. The sun gear 34 in turn drives a plurality of planet gears 40. The planet gears 40 include output gear teeth 41, which drive a ring gear 42. The ring gear 42 drives the output shaft 28 through a mechanical connection.

In addition, a bearing sleeve 54 is supported within a gear cage 50. As can be seen, a plurality of bearings 112 are surrounded by the bearing sleeve 54, and support the turbine shaft 32. An anti-rotation connection between the gear cage 50 and the bearing sleeve 54 is provided in part by a liner 52.

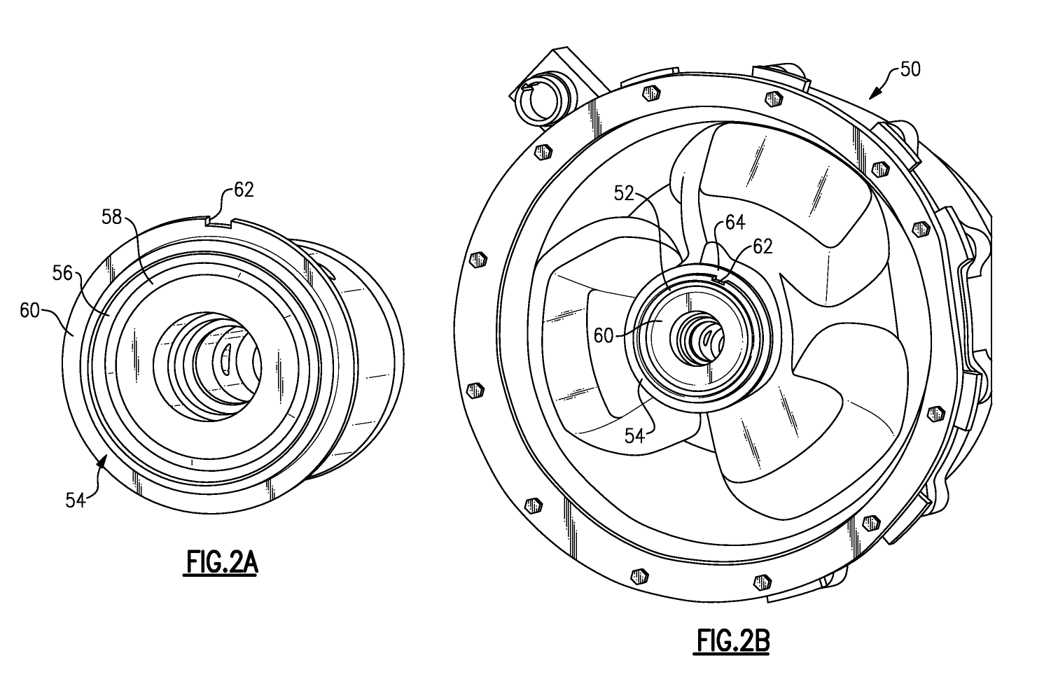

FIG. 2A shows the bearing sleeve 54 having a flange 60, and an anti-rotation slot 62. A clip 56 secures an outer end 58 (the housing of the seal assembly) of the bearing assembly within the bearing sleeve 54.

FIG. 2B shows the bearing sleeve 54 mounted within a gear cage 50. The liner 52 is positioned intermediate the two. As can be seen, a tab 64 on the liner 52 fits into the slot 62 to provide an anti-rotation feature. As can be appreciated, this anti-rotation feature is at the rotor end of the air turbine starter turbine assembly 20, and thus any debris will fall outwardly into an air flow portion, rather than into a gear train portion of the assembly 20.

FIG. 3 shows a detail, showing the clip 56 securing the outer end 58, seal portions 110, and the bearings 112 about the shaft 32. As can be seen, the liner 52 is secured within an outer lip 100 of the gear cage 50. A flat face or surface 101 of the gear cage 50 provides a stop surface for the liner 52. A lower portion of the cage 50 and the liner 52 can be seen to have a machined-away face 102 and 104. These faces do not extend axially as far toward the rotor 26 as tab 64 portion 100. Instead, the portion 100, and the tab 64 as shown in the top portion of FIG. 3 extend only over a very limited circumferential extent to provide the locking feature. Elsewhere, the flange 60 of the bearing sleeve 54 sits adjacent both surfaces 102 and 104. In one embodiment, a stack of shims, for example one thick and three thinner ones, set the axial position of the bearing sleeve 54, and thus the turbine rotor 26, such that the bearing sleeve 54 does not typically abut surfaces 102 and 104. This is done to achieve a specific axial clearance between the rotor and another part of the starter.

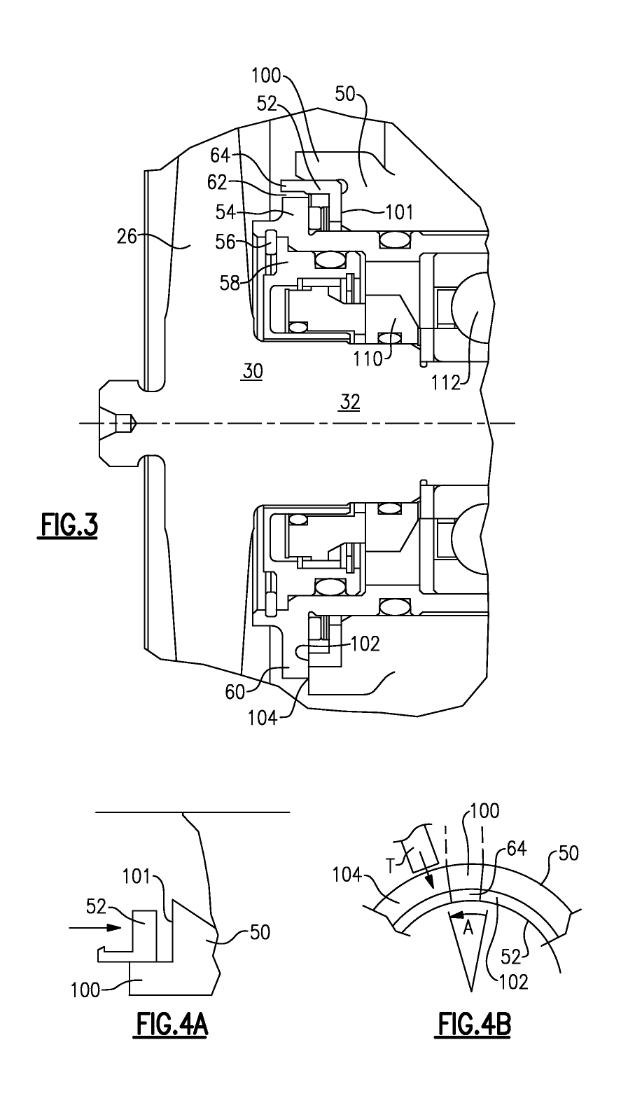

FIG. 4A shows a first step in the assembly of the gear cage 50. As shown, the gear cage 50 has surfaces 101 and 100, and the liner 52 is force fit into the opening formed between the surfaces 100 and 101. The liner 52 may be made of a relatively hard metal, such as steel, while the gear cage 50 may be made of aluminum. Notably, the bearing sleeve 54 may also be made of steel. Thus, the anti-rotation function will be provided by steel on steel contact. Of course, other materials could come within the scope of this invention.

FIG. 4B shows a subsequent step. Once the liner 52 is force fit into the cage 50, a tool T machines away the bulk of the material such that almost all of the gear cage 50 and liner 52 sit further away from the rotor, such as in the lower portion of FIG. 3. However, over a limited circumferential angle A, the anti-rotation tab 64 and the extending portion 100 are found. The angle A is between 4° and 12° in one embodiment. It should be understood that after this machining, the bearing sleeve 54 with the rest of the turbine balance assembly (the bearings 112, the seals 110, the rotor 26 and shaft 32) can all be inserted into the gear cage 50, and the anti-rotation function is provided by the inter-lock between tab 64 and slot 62.

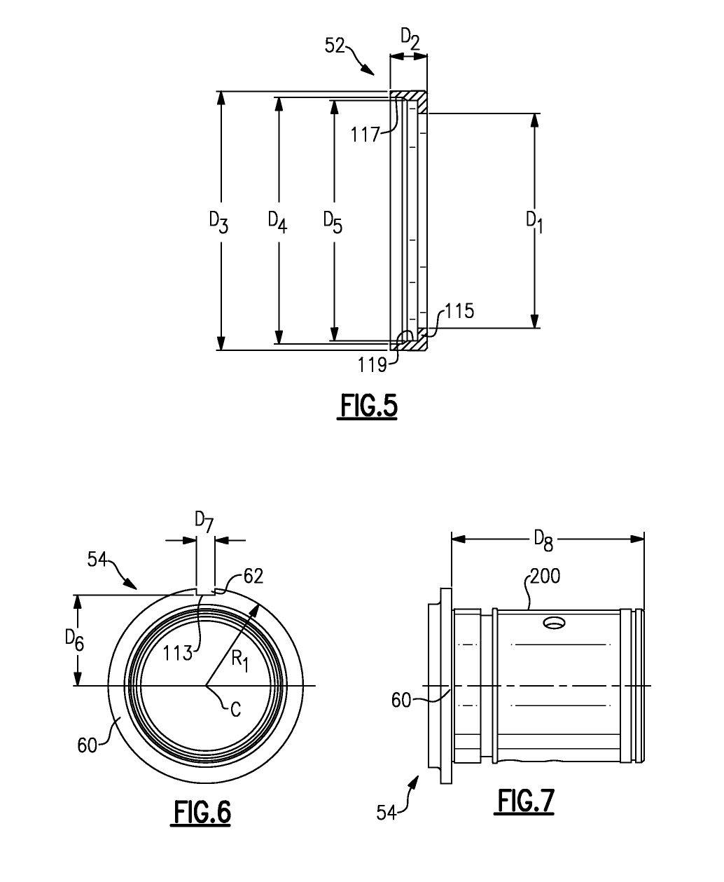

FIG. 5 shows a detail of the liner 52. As shown, a forward end 117 of the liner 52 has a greater interior diameter than a more remote portion 119. The inner diameter of an inner end 115 of the liner is at a distance D₁. In one embodiment, this distance was 1.97″ (5.00 cm). The forwardly extending flange portion of the liner 52 extends for a distance D₂. In one embodiment, this distance was 0.181″ (0.460 cm). The outer diameter D₃ of the liner 52 was 2.34″ (5.94 cm). The inner diameter of the portion 117 is at a diameter D₄ and in one embodiment 2.25″ (5.71 cm). The inner diameter of the more interior portion 119 was at a diameter D₅, and in one embodiment 2.21″ (5.61 cm). Of course, other diameters may be utilized.

The eventual tab 64 will be formed in the portion 117.

A ratio of the inner diameter D₄ of the portion 117, to the outer diameter D₃ of the overall liner is between 0.92 and 0.98.

A ratio of D₂ to D₄ is between 12.5 and 4.5.

FIG. 6 shows a detail of the bearing sleeve 54. As shown, the flange 60 sits at a nominal radius R₁ that was 1.175″ (2.984 cm). The tab 62 has an inner end 113 which is at a tangent to a central axis C of the bearing sleeve 54. The surface 113 is at a distance D₆, and in one embodiment, that was 1.10″ (2.79 cm). A width D₇ between the sides of the notch 62 in one embodiment was 0.208″ (0.528 cm).

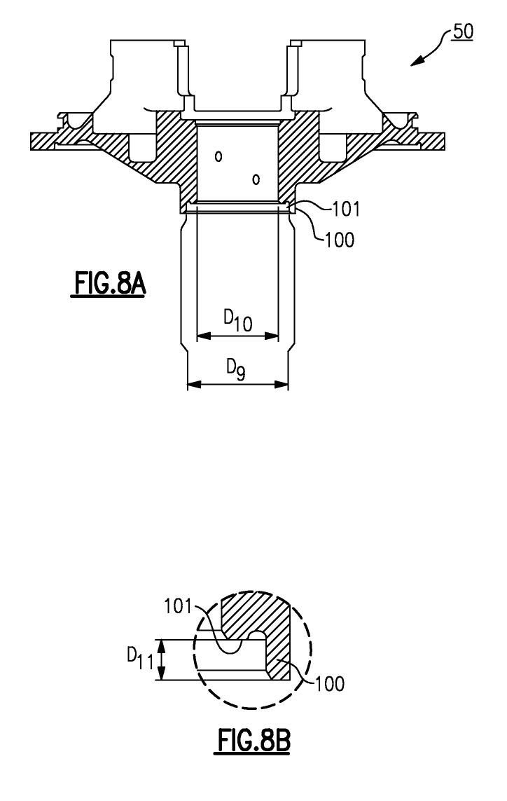

As shown in FIG. 7, a length D₈ of a support portion 200 of the sleeve 54 was 2.33″ (5.91 cm).

In embodiments, a ratio of the distances D₆ to R₁ was between 0.92 and 0.95. A ratio of the distance D₇ to the radius R₁ was between 0.09 and 0.22.

FIG. 8A shows a detail of the gear cage 50. As shown, an inner diameter D₉ can be defined to the inner surface of the portion 100, and an inner diameter D₁₀ can be defined to the inner periphery of the nominal bore through the gear cage 50. In one embodiment, D₁₀ was 1.87″ (4.74 cm), and D₉ was 2.24″ (5.99 cm).

As shown in FIG. 8B, another distance D₁₁ can be defined between an end of the surface 101, and an outer end of the portion 110. The distance D₁₁ was 0.09 in one embodiment. A ratio of D₉ to D₁₁ was between 0.03 and 0.06.

Of course, other shapes and dimensions would come within the scope of this application.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A turbine balance assembly comprising:
a turbine rotor connected to drive a turbine shaft;
bearings positioned radially outwardly of said turbine shaft;
a bearing sleeve positioned radially outwardly of said bearings, and supporting said bearings, said bearing sleeve extending along an axial length defined by a rotational axis of said shaft, and said bearing sleeve having a turbine rotor end adjacent to said turbine rotor, and a remote end;
a radially outwardly extending flange on said bearing sleeve extending radially outwardly of a support portion of said bearing sleeve and at said turbine rotor end, and said flange having a nominal outer radius, and including a slot for receiving an anti-rotation lock over a limited circumferential extent.

2. The turbine balance assembly as set forth in claim 1, wherein said slot extends over an angle of between 4° and 12° to define said limited circumferential extent.

3. The turbine balance assembly as set forth in claim 1, wherein a ratio between a distance from a center line of said bearing sleeve to a tangent point for a flat surface on a radially inner end of said tab relative to said nominal radius of the flange is between 0.92 and 0.95.

4. The turbine balance assembly as set forth in claim 3, wherein said slot extends for a distance along said flat surface between two sides, and a ratio of the distance between said two sides to said nominal radius is between 0.09 and 0.22.

5. An air turbine starter comprising:
a turbine rotor connected to drive a turbine shaft;
bearings positioned radially outwardly of said turbine shaft;
a bearing sleeve positioned radially outwardly of said bearings, and supporting said bearings, said bearing sleeve extending along an axial length defined by a rotational axis of said shaft, and said bearing sleeve having a turbine rotor end adjacent to said turbine rotor, and a remote end;
a radially outwardly extending flange on said bearing sleeve extending radially outwardly of a support portion of said bearing sleeve and at said turbine rotor end, and said flange having a nominal outer diameter, and including a slot for receiving an anti-rotation lock over a limited circumferential extent; and
a gear cage including an anti-rotation tab extending into said slot to resist rotation of said bearing sleeve relative to said gear cage.

6. The air turbine starter as set forth in claim 5, wherein said slot extends over an angle of between 4° and 12° to define said limited circumferential extent.

7. The air turbine starter as set forth in claim 5, wherein a ratio between a distance from a center line of said bearing sleeve to a tangent point for a flat surface on a radially inner end of said slot relative to said nominal radius of the flange is between 0.92 and 0.95.

8. The air turbine starter as set forth in claim 7, wherein said slot extends for a distance along said flat surface between two sides, and a ratio of the distance between said two sides to said nominal radius is between 0.09 and 0.22.

9. The air turbine starter as set forth in claim 5, wherein said gear cage is formed of an outer aluminum member having an inner bore, and a steel liner force fit into said inner bore, said tab being part of said steel liner.

10. The air turbine starter as set forth in claim 9, wherein said tab and said outer aluminum member extend along the axial dimension closer to said rotor over a limited circumferential extent associated with said slot, and said steel liner and said gear cage having surfaces that are more removed from said turbine rotor at locations other than said limited circumferential extent.

11. The air turbine starter as set forth in claim 9, wherein said steel liner has the tab formed in an axially forward end spaced more toward said turbine rotor than a remote end, and there being an outer diameter of said steel liner, and a ratio of an inner diameter of said forward end to said outer diameter is between 0.92 and 0.98.

12. The air turbine starter as set forth in claim 11, wherein a ratio of said inner diameter of said forward end to an axial length of the entire steel liner is between 12.5 and 4.5.

13. A gear cage comprising:
an outer aluminum member having a cylindrical inner bore;
a steel liner force fit into said inner bore, a tab being formed as part of said steel liner, and said tab and said outer aluminum member extending along an axial dimension more forwardly than a nominal face of said liner and said outer aluminum member, and over a limited circumferential extent; and
wherein said steel liner has the tab formed in an axially forward end spaced more toward said turbine rotor than a remote end, and there being an outer diameter of said steel liner, and a ratio of an inner diameter of said forward end to said outer diameter is between 0.92 and 0.98.

14. The gear cage as set forth in claim 13, wherein a ratio of said inner diameter of said forward end to an axial length of the entire steel liner is between 12.5 and 4.5.

15. A bearing sleeve having a support portion extending along a central axis, and having a flange at a turbine end extending radially outwardly; and
said flange having a nominal outer radius, and a slot for receiving an anti-rotation lock over a limited circumferential extent, said slot extending over an angle of between 4° and 12° to define said limited circumferential extent.

16. The bearing sleeve as set forth in claim 15, wherein a ratio between a distance from a center line of said bearing sleeve to a tangent point for a flat surface on a radially inner end of said slot relative to said nominal radius of the flange is between 0.92 and 0.95.

17. The bearing sleeve as set forth in claim 16, wherein said slot extends for a distance along said flat surface between two sides, and a ratio of the distance between said two sides to said nominal radius is between 0.09 and 0.22.

18. A method of assembling an air turbine starter comprising the steps of:
inserting a turbine rotor and shaft, and bearings supporting said shaft into a bearing sleeve to form a turbine balance assembly, and said bearing sleeve having a slot to receive an anti-rotation structure at an end of said bearing sleeve positioned toward said turbine rotor; and
moving said turbine balance assembly into a gear cage, said gear cage having an anti-rotation tab and said tab being moved into said slot.

19. The method as set forth in claim 18, wherein said gear cage is formed of an outer member having an inner bore, and a liner force fit into said inner bore, with said liner providing the tab.

20. The method as set forth in claim 19, wherein said outer member and said liner initially have cylindrical forward surfaces, and said cylindrical forward surfaces of said outer aluminum member and said liner are machined away to leave said tab, and a portion of said cylindrical forward surfaces of said outer member over a limited circumferential extent prior to said turbine balance assembly being inserted within said gear cage.
